(19) United States
(12) Patent Application Publication
(10) Pub. No.: US 2021/0219531 A1
(43) Pub. Date: Jul. 22, 2021

(54) Fishing Line Cutter

(71) Applicant: Gallco All Outdoors, Lake Toxaway, NC (US)

(72) Inventor: Kevin Scott Galloway, Lake Toxaway, NC (US)

(21) Appl. No.: 17/149,581

(22) Filed: Jan. 14, 2021

Related U.S. Application Data
(60) Provisional application No. 62/962,645, filed on Jan. 17, 2020.

(51) Int. Cl. A01K 97/00

(52) U.S. Cl. CPC A01K 97/00

(57) ABSTRACT

A fishing line cutter includes a pole bracket, a lever, a spring-loaded pin assembly, and a blade. The pole bracket attaches to a fishing pole and includes a main body, a first support, and a second support. The lever includes a handle, a third support, and a fourth support and functions as the body that applied pressure to a fishing line. The first support and the second support are oppositely positioned of each other about the main body. The third support and the fourth support are oppositely positioned of each other about the handle. The first support and the second support are compressionally mounted to the third support and the fourth support by the spring-loaded pin assembly. The blade is connected onto the handle and oriented toward the main body so that the pressure applied by the lever can be transferred to the fishing line.

The current application claims a priority to the U.S. Provisional Patent application Ser. No. 62/962,645 filed on Jan. 17, 2020.

### FIELD OF THE INVENTION

The present invention relates generally to a fishing pole attachment. More specifically, the present invention is a cutting apparatus that attaches to the fishing pole so that the user can conveniently cut fishing lines.

### BACKGROUND OF THE INVENTION

A fishing line is a high strength cord that is mainly used for angling. Fishing lines generally resemble a long, thin string, and vary in material. Important attributes of a fishing line include length, material, weight, thickness, and other factors relevant to certain fishing environments such as breaking strength, knot strength, UV resistance, castability, limpness, stretch, abrasion resistance, and visibility. Most modern fishing lines are made from nylon, braided polymers, or silk. Generally, users of the fishing lines requires a line cutting apparatus such as a scissor, a pocketknife, a clipper, a cutting plyer, and other handheld cutting devices to cut or trim a fishing line. All of these existing cutting apparatus are kept and used separate from a fishing pole thus resulting complications and unexpected problems for the user. For examples, the users tend to loss or misplace these cutting apparatus. Furthermore, these existing cutting apparatus can also be cumbersome. Furthermore, these existing cutting apparatus can also require both of the user's hands to operate thus forcing the user to put down the fishing pole.

It is there for an objective of the present invention to provide a cutting apparatus that attaches to the fishing pole. The present invention is able to cut or trim the fishing lines thus preventing the user from having to use a separate cutting apparatus or even biting the line. The present invention is conveniently attached to the fishing pole for easy use every time and only requires one of the user's hand. Furthermore, the present invention can be premanufactured or retrofitted into a fishing pole thus providing a hassle free, inexpensive, and user friendly cutting apparatus to the users.

### BRIEF DESCRIPTION OF THE DRAWINGS

FIG. 1 is a perspective view of the present invention showing the rotational axis and the sagittal plane.

FIG. 2 is a top view of the present invention.

FIG. 3 is a side view of the present invention.

FIG. 4 is a bottom exploded view of the present invention.

FIG. 5 is a top exploded view of the present invention.

### DETAIL DESCRIPTIONS OF THE INVENTION

All illustrations of the drawings are for the purpose of describing selected versions of the present invention and are not intended to limit the scope of the present invention.

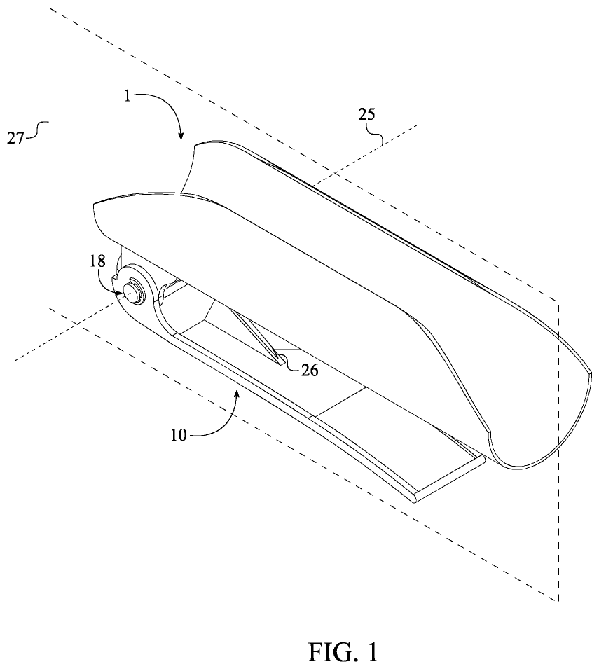

The present invention is a cutting apparatus that attaches to a fishing pole so that the user can cut or trim the fishing lines. The present invention eliminates the user from having to use a separate cutting apparatus or even biting the line as the present invention is conveniently attached to the fishing pole for easy. Furthermore, the present invention only requires one hand to operate thus allowing the user to grasp the fishing pole. The present invention comprises a pole bracket 1, a lever 10, a spring-loaded pin assembly 18, a blade 26, and a sagittal plane 27 as shown in FIG. 1.

In reference to the general configuration of the present invention, the pole bracket 1 and lever 10 are compressionally connected to each other through the spring-loaded pin assembly 18 as the blade 26 is able to cut or trim the fishing line. The pole bracket 1 comprises a main body 2, a first support 8, and a second support 9 in such a way that the first support 8 and the second support 9 are oppositely positioned of each other about the main body 2. The lever 10 comprises a handle 11, a third support 14, and a fourth support 15 in such a way that the third support 14 and the fourth support 15 are oppositely positioned of each other about the handle 11. The first support 8 and the second support 9 are compressionally mounted to the third support 14 and the fourth support 15 by the spring-loaded pin assembly 18 thus pushing apart the lever 10 and the pole bracket 1 from each other. The blade 26 is connected onto the handle 11 and positioned along the sagittal plane 27. The blade 26 is oriented toward the main body 2 so that the blade 26 can cut or trim the fishing line against the pole bracket 1 when pressure is applied to the lever 10.

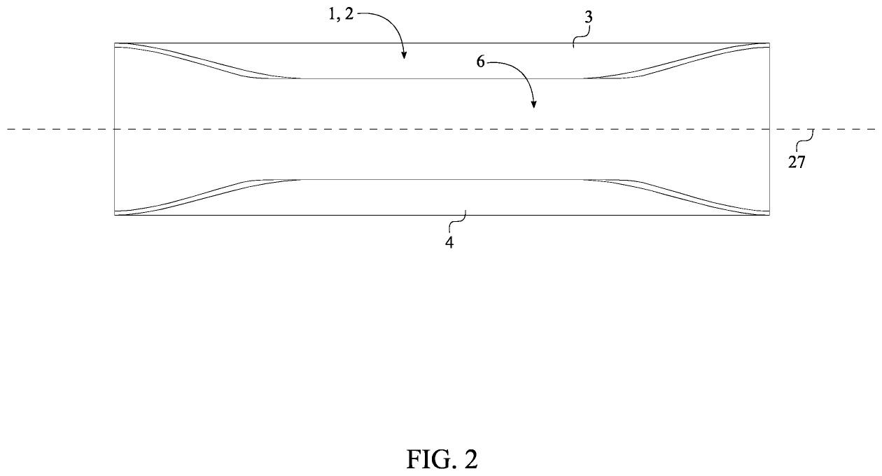

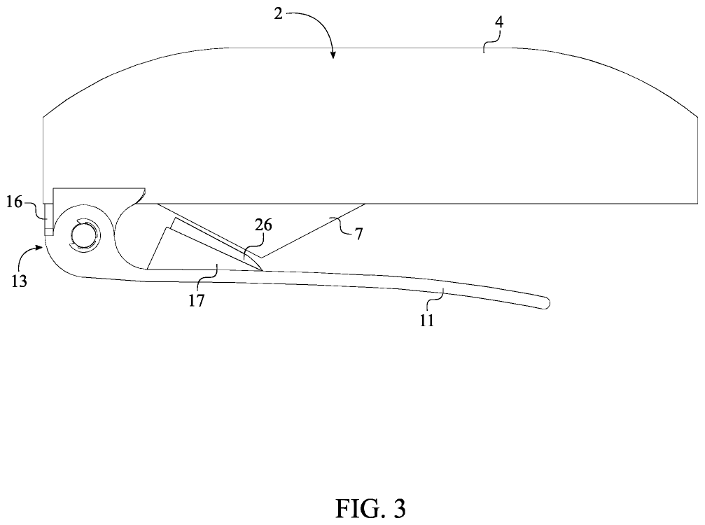

The main body 2 function as an attachment bracket for the fishing pole so that the present invention can be securely mounted. As shown in FIG. 2. the main body 2 comprises a first curved arm 3, a second curved arm 4, an elongated opening 6, and a base platform 7. The first curved arm 3 and the second curved arm 4 are adjacently connected to each other along the sagittal plane 27 thus forming a C-shaped profile for the main body 2. The elongated opening 6, which allows the main body 2 to be snapped into a fishing pole, is delineated in between a free end 5 of the first curved arm 3 and a free end 5 of the second curved arm 4. As result, the user can align the elongated opening 6 along the length of the fishing pole and pressed the main body 2 towards the fishing pole. Then, the first curved arm 3 and the second curved arm 4 elastically flex outwards snap around the fishing pole to secure the present invention. Furthermore, the main body 2 can utilize an adhesive strip that is integrated into an inner surface of the main body 2 to enhance the connection between the present invention and the fishing pole. As shown in FIG. 3-5, the base platform 7 is externally connected onto the first curved arm 3 and the second curved arm 4 and symmetrically oriented away from the elongated opening 6. The base platform 7 provide a rigid structure that is oriented towards the handle 11 so that the blade 26 can come down and compressed against the base platform 7. In other words, the base platform 7 functions as a stop-block to the blade 26 thus enabling the blade 26 to cut or trim the fishing line.

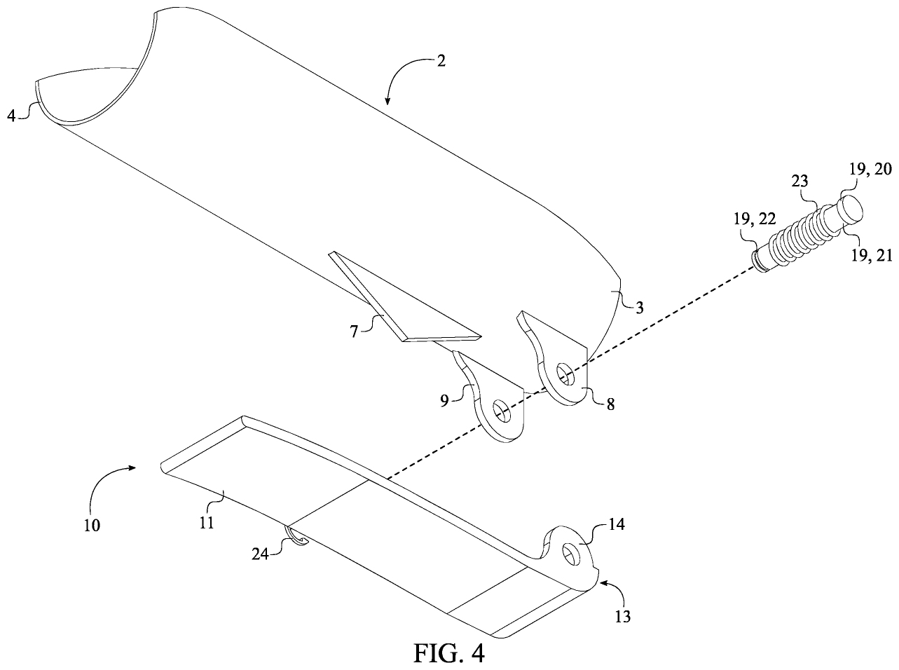

In reference to FIG. 4, the first support 8 is adjacently connected to the first curved arm 3 and supports the rotation of the lever 10 with respect to the third support 14. The second support 9 is adjacently connected to the second curved arm 4 and supports the rotation of the lever 10 with respect to the third support 14. As a result, the first support 8 and the second support 9 are perpendicularly aligned with a rotational axis 25 of the spring-loaded pin assembly 18 so that the lever 10 can rotate about the spring-loaded pin assembly 18.

The handle 11 functions as the structural body that applies pressure to the cut or trim the fishing line. More specifically, the handle 11 is ergonomically shaped so that the user can comfortably place their fingers to press the handle 11 towards the main body 2 as shown in FIG. 3. For example, the user places their figures about an outside surface of the handle 11, the user can press the handle 11 towards the main body 2 to apply pressure to the fishing line. The third support 14 is adjacently connected to the handle 11 and supports the rotation of the lever 10 with respect to the first support 8. The fourth support 15 is adjacently connected to the handle 11 and supports the rotation of the lever 10 with respect to the first support 8. As a result, the third support 14 and the fourth support 15 are perpendicularly aligned with the rotational axis 25 of the spring-loaded pin assembly 18 so that the lever 10 can rotate about the spring-loaded pin assembly 18.

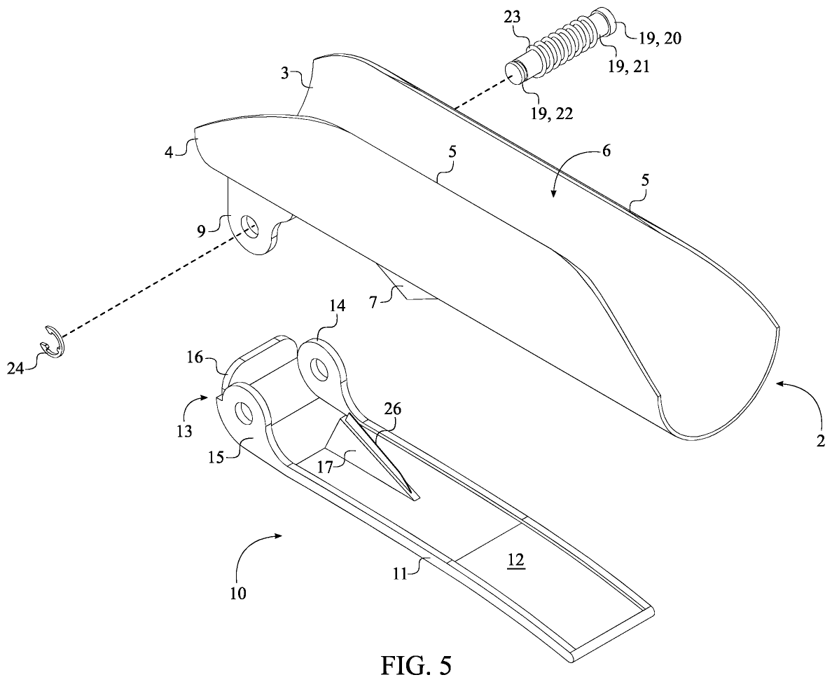

In reference to FIG. 3 and FIG. 5, the lever 10 further comprises a stopper 16 so that the outward rotational movement of the lever 10 that is created from the spring-loaded pin assembly 18 can be controlled or limited. More specifically, the stopper 16 is terminally connected to a rear end 13 of the handle 11 and symmetrically positioned about the sagittal plane 27. Due to the spring force of the spring-loaded pin assembly 18, the stopper 16 presses against the main body 2 and limits the outward rotational movement the lever 10 so that the user can press the handle 11 towards the main body 2.

In reference to FIG. 3 and FIG. 5, the lever 10 further comprising a mount 17 that functions as the intermediate body in between the blade 26 and the handle 11. More specifically, the mount 17 is terminally connected to an inside surface 12 of the handle 11 and symmetrically positioned about the sagittal plane 27. As a result, the blade 26 is terminally connected to the mount 17 and oriented toward the base platform 7.

In reference to FIG. 4-5, the spring-loaded pin assembly 18 that mounts the lever 10 to the pole bracket 1 comprises a connector pin 19, a spring 23, and a fastener clip 24. A head 20 of the connector pin 19 is compressed against the third support 14 so that a shaft 21 of the connector pin 19 is able to rotatably traverse through the first support 8, the second support 9, the third support 14, and the fourth support 15. The spring 23 is concentrically engaged around the shaft 21 of the connector pin 19 and positioned in between the first support 8 and the second support 9. The spring 23 is able to apply spring force to the lever 10 and generate the outward rotational movement of the lever 10. The fastener clip 24 is engaged around a tip 22 of the connector pin 19 and adjacently positioned to the fourth support 15. As a result, the fastener clip 24 is able to retain the connector pin 19 within the first support 8, the second support 9, the third support 14, and the fourth support 15. Preferably, an E-clip is utilized as the fastener clip 24 within the present invention. However, the present invention can use any other type of fastener mechanism as long as the corresponding fastener mechanism is able to secure the connector pin 19 within the first support 8, the second support 9, the third support 14, and the fourth support 15.

In order to cut or trim the fishing line, the fishing line is first placed between the blade 26 and the base platform 7. Then, the user can apply pressure to the handle 11 which in turns presses the handle 11 towards the main body 2. Once the blade 26 is able to contact the fishing line, the applied pressure from the handle 11 is able to cut or trim the fishing line as the blade 26 goes through the fishing line and contact the base platform 7. Then, the user can release the handle 11 thus allowing the handle 11 to return back to its neutral position.

Although the invention has been explained in relation to its preferred embodiment, it is to be understood that many other possible modifications and variations can be made without departing from the spirit and scope of the invention as hereinafter claimed.

What is claimed is:

1. A fishing line cutter comprising:
a pole bracket;
a lever;
a spring-loaded pin assembly;
a blade;
a sagittal plane;
the pole bracket comprising a main body, a first support, and a second support;
the lever comprising a handle, a third support, and a fourth support;
the first support and the second support being oppositely positioned of each other about the main body;
the third support and the fourth support being oppositely positioned of each other about the handle;
the first support and the second support being compressionally mounted to the third support and the fourth support by the spring-loaded pin assembly;
the blade being connected onto the handle;
the blade being positioned along the sagittal plane; and
the blade being oriented toward the main body.

2. The fishing line cutter as claimed in claim 1 comprising:
the main body comprising a first curved arm, a second curved arm, an elongated opening, and a base platform;
the first curved arm and the second curved arm being adjacently connected to each other along the sagittal plane;
the elongated opening being delineated in between a free end of the first curved arm and a free end of the second curved arm;
the base platform being externally connected onto the first curved arm and the second curved arm; and
the base platform being symmetrically oriented away from the elongated opening.

3. The fishing line cutter as claimed in claim 2 comprising:
the first support being adjacently connected to the first curved arm;
the second support being adjacently connected to the second curved arm;
the first support being perpendicularly aligned with a rotational axis of the spring-loaded pin assembly; and
the second support being perpendicularly aligned with the rotational axis of the spring-loaded pin assembly.

4. The fishing line cutter as claimed in claim 1 comprising:
the third support being adjacently connected to the handle;
the fourth support being adjacently connected to the handle;
the third support being perpendicularly aligned with a rotational axis of the spring-loaded pin assembly; and
the fourth support being perpendicularly aligned with the rotational axis of the spring-loaded pin assembly.

5. The fishing line cutter as claimed in claim 1 comprising:
the lever further comprising a stopper;
the stopper being terminally connected to a rear end of the handle;
the stopper being symmetrically positioned about the sagittal plane; and
the stopper being pressed against the main body.

6. The fishing line cutter as claimed in claim 1 comprising:
the lever further comprising a mount;
the mount being terminally connected to an inside surface of the handle;
the mount being symmetrically positioned about the sagittal plane; and
the blade being terminally connected to the mount.

7. The fishing line cutter as claimed in claim 1 comprising:
the spring-loaded pin assembly comprising a connector pin, a spring, and a fastener clip;
a head of the connector pin being compressed against the third support;
a shaft of the connector pin rotatably traversing through the first support, the second support, the third support, and the fourth support;
the spring being concentrically engaged around the shaft of the connector pin;
the spring being positioned in between the first support and the second support;
the fastener clip being engaged around a tip of the connector pin; and
the fastener clip being adjacently positioned to the fourth support.
